(19) United States
(12) Patent Application Publication
(10) Pub. No.: US 2025/0233856 A1
(43) Pub. Date: Jul. 17, 2025

(54) SYSTEMS AND METHODS FOR AUTHENTICATING ACCOUNT CHANGES IN A WIRELESS NETWORK

(71) Applicant: T-Mobile Innovations LLC, Overland Park, KS (US)

(72) Inventor: Ahmad AL ACCAD, Renton, WA (US)

(21) Appl. No.: 18/413,638

(22) Filed: Jan. 16, 2024

(51) Int. Cl. H04L 9/40; H04W 4/14

(52) U.S. Cl. CPC H04L 63/0838; H04W 4/14

(57) ABSTRACT

Systems and methods are provided for authenticating account modifications in a wireless network. Methods include detecting a request to modify an account of an account holder, at an authentication portal. The methods further include transmitting a request to generate a one-time password (OTP) to an identity provider, wherein the request to generate the OTP includes a confirmation flag indicating that confirmation by the account holder is required before generating the OTP. The methods further include transmitting an SMS message to the account holder identifying the request to modify the account and requesting a positive confirmation from the account holder to authorize the requested account modification. The methods further include transmitting the OTP via SMS to the account holder upon receiving the positive confirmation from the account holder.

### TECHNICAL BACKGROUND

Cellular subscriber accounts are increasingly becoming sought after targets of cyber-criminals. The accounts can be bought and sold, used to make large fraudulent purchases, and even used in other criminal activity. Like most online accounts, they tend to be secured with a username and password combination. Since these credentials may be vulnerable on their own, it is common for online accounts to make an extra layer of security available to their account holders in the form of one-time passwords (OTP). But now even OTPs are becoming susceptible to phishing attempts by cyber-criminals and other bad actors.

### OVERVIEW

Examples described herein include systems and methods for authenticating account changes in a wireless network. An exemplary method includes detecting a request to modify an account of an account holder, at an authentication portal. The method further includes transmitting an SMS message to the account holder identifying the attempt to modify the account and requesting a positive confirmation from the account holder to authorize the modification. The method further includes transmitting an OTP via SMS to the account holder upon receiving the positive confirmation from the account holder. The method further includes upon receiving the OTP at the authentication portal, modifying the account, and transmitting an SMS notification to the account holder indicating that the requested account modification has been completed.

Another exemplary embodiment includes a system including an authentication portal, an identity provider, and an SMS delivery service. The authentication portal includes at least one electronic processor configured to perform authentication operations. The authentication operations include receiving a request from a user to modify an account of an account holder. The authentication operations further include transmitting to the identity provider a request to generate a generated OTP containing a confirmation flag indicating that confirmation is required by the account holder before generating the generated OTP. The authentication operations further include receiving a received OTP from the user and upon receiving the received OTP, transmitting the received OTP to the identity provider. The authentication operations further include performing the requested account modification once the received OTP is validated.

The identity provider includes at least one electronic processor configured to perform identity operations. The identity operations include upon receiving the request to generate a generated OTP, transmitting a confirmation request message to the SMS delivery service, wherein the confirmation message notifies the account holder of the request to modify the account and instructs the account holder to reply with a positive confirmation response to approve the requested account modification. The identity operations further include generating a generated OTP upon receiving the positive confirmation response. The identity operations further include transmitting the generated OTP to the SMS delivery service. The identity operations further include receiving the received OTP from the authentication portal. The identity operations further include validating that the received OTP matches the generated OTP and if validated, transmitting a notification to the authentication portal indicating the validation.

The SMS delivery service includes at least one electronic processor configured to perform delivery operation. The delivery operations include transmitting the confirmation request message to the account holder. The delivery operations further include receiving the positive confirmation response from the account holder. The delivery operations further include transmitting the positive confirmation message to the identity provider. The delivery operations further include transmitting the generated OTP to the account holder upon receiving the generated OTP from the identity provider.

Another exemplary embodiment includes a method of authenticating account modifications. The method includes receiving a request from a user to modify the account of an account holder at an authentication portal. The method further includes transmitting a request to generate a generated OTP to an identity provider, wherein the request to generate the generated OTP includes a confirmation flag indicating that confirmation from the account holder is required to authorize the requested account modification. The method further includes transmitting an SMS confirmation request to the account holder, wherein the SMS confirmation request indicates that the account modification has been requested and asks the account holder to provide a positive confirmation response to authorize the requested account modification or a negative confirmation response to prevent the requested account modification. The method further includes receiving the positive confirmation response via SMS from the account holder. The method further includes upon receiving the positive confirmation response, generating the generated OTP, and transmitting the generated OTP to the account holder. The method further includes receiving a received OTP at the authentication portal. The method further includes upon validating that the received OTP matches the generated OTP, performing the requested account modification and notifying the account holder via SMS that the requested account modification has been completed.

### BRIEF DESCRIPTION OF THE DRAWINGS

These and other more detailed and specific features of various embodiments are more fully disclosed in the following description, reference being had to the accompanying drawings, in which:

FIG. 1 illustrates an exemplary system for authenticating account modification in a wireless network in accordance with various aspects of the present disclosure;

FIG. 2 illustrates an exemplary processing node in accordance with various aspects of the present disclosure;

FIG. 3 illustrates an exemplary process flow for authenticating account modifications in a wireless network; and

FIG. 4 illustrates an exemplary process flow for authenticating account modifications in a wireless network.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In accordance with various aspects of the present disclosure, a cellular or wireless network may be provided by a wireless provider. Access to the cellular account may be made available to the account holder via the wireless provider's website. The account holder is required to login to their account to gain access to their account details, usually by way of a username and password. Once authenticated, the account holder can perform many different functions such as adding or removing lines, ordering new equipment, or changing service levels, for example. There are also many functions that are common to other types of online accounts as well, such as changing the account's password or the account holder's contact information including mailing address or email address. Online accounts, whether for cellular subscribers or otherwise, also have mechanisms for when an account holder forgets their username or password. Often this is presented at the login page as a link for resetting a forgotten password. The user will then be presented with options to verify the person requesting the password reset. This can be done by having the provider send an email to the email address on record for the account, having the user answer security questions, using an external authenticator application, or via an OTP sent via SMS to the account holder's mobile phone. Each of those methods may have different levels of convenience and vulnerability.

Recently, OTPs sent via SMS have increasingly been coming under attack by bad actors using phishing methods on unsuspecting victims. Phishing is a social engineering attack where the victim is convinced to divulge confidential information under false pretenses. A common scheme is to send an SMS message to the victim claiming they have won something, such as money and stating that all they need to do is confirm the OTP that they will send. The bad actor then triggers the reset password mechanism causing the cellular provider to send an OTP to the account holder's phone. If the account holder falls for the scheme, they then send the OTP to the bad actor by replying to the phishing SMS message with the OTP. The bad actor then uses the OTP to reset the password on the account holder's account and now has full access to the account. Even though there is always a warning accompanying the OTP stating never to share the OTP with anyone, it is often ignored by those falling for phishing schemes such as these. These types of phishing attacks may be thwarted by adding an extra confirmation step. The extra step including requiring a positive confirmation from the account holder before continuing the process of modifying the account, such as resetting the password.

The process for resetting a password begins when the user is presented with a login page by an authentication portal. The login page will have a link for when the user needs to reset their password. Upon clicking the reset password link, the user is presented with different methods of verifying their identity depending on how the individual account is setup. For example, if the account profile includes security questions and answers, then that will be one of the possible ways to verify the user. Other ways of verifying the user include sending an OTP to the account holder's email address or sending an OTP via SMS to the account holder's phone number. The user may select the SMS OTP option which will start the process for an SMS confirmation message to be sent to the account holder's phone number. This confirmation message may be triggered by sending a command to an identity provider to generate the OTP and including a new parameter within the command indicating that confirmation is required before creating the OTP. The command to generate the OTP may be the “generateTempPin” command and the parameter may be Boolean and contain “True” when confirmation is required and “False” when confirmation is not required, for example. The identity provider would send the confirmation message to a service delivery gateway including the text of the SMS confirmation message. The text of this message would include the operation being attempted and instructions requesting a positive or negative confirmation of the action. For example, the text could include, “Someone is trying to reset your account password. Please confirm it is you by replying YES to this message. If it was not you, please reply NO to this message”. The service delivery gateway would then forward the message to an SMS center which then forwards it to the account holder's mobile device. At that point, the account holder may respond with a positive confirmation (YES), a negative confirmation (NO) or not respond at all.

A positive confirmation reply will be sent through the SMS center and the delivery gateway making its way to the identity provider. At that point, the user is considered verified, and the identity provider generates the OTP and sends it back through the delivery gateway and SMS center to the account holder's device. The authentication portal will present to the user a dialog box for inputting the OTP. The user will input the OTP and the authentication portal will forward the OTP to the identity provider for verification. If the OTP is verified, the account change is authorized, and the user is prompted to input a new password. The new password is forwarded to the identity provider. The identity provider may then trigger a confirmation SMS message confirming that the account change has been completed. The confirmation SMS message will be forwarded to the delivery gateway and SMS center and eventually to the account holder's device.

A negative confirmation reply will be sent through the SMS center and the delivery gateway making its way to the identity provider. If the identity provider receives the negative confirmation reply or receives no reply at all after a predetermined period of time, the user is considered unverified, and the account modification will be denied. At that point, the identity provider may generate a confirmation SMS message stating that the account modification has been stopped. The confirmation SMS message will be forwarded through the delivery gateway and SMS center and eventually to the account holder's device.

The delivery gateway and SMS center may be an optional method of delivering SMS messages and may be performed by other means. For example, they may be combined into a single service or SMS delivery could be performed by another entity.

The same confirmation process may be used for other account

modifications than just the password reset as well. For example, a request to change the account's password or contact information may require the use of an OTP for confirmation and therefore may use the confirmation process disclosed herein to further secure those account modifications as well.

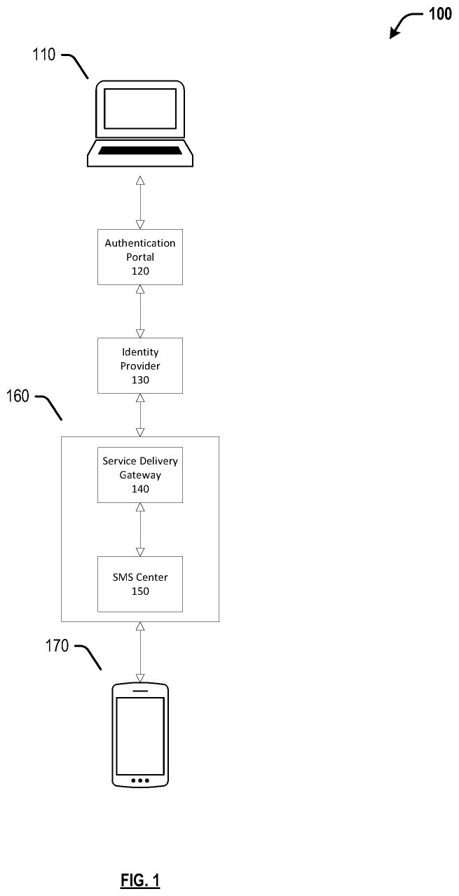

FIG. 1 depicts an exemplary system 100 for authenticating account changes in a wireless network. System 100 includes a user's computer 110. While this is shown in FIG. 1 as a laptop computer, it could be any electronic device with the capability of accessing the login web page of the account provider. Examples include, a laptop or desktop computer, a mobile phone or a tablet. System 100 further includes an authentication portal 120, an identity provider 130, and an SMS delivery service 160. The SMS delivery service 160 includes a service delivery gateway 140, and an SMS center 150. The service delivery gateway 140 provides many different delivery routing services outside the scope of this disclosure. The SMS delivery service 160 is a logical representation of the service delivery gateway 140 and the SMS center 150 for the purposes of clarity and to illustrate how those two elements work together to transmit SMS messages back and forth between the provider and the account holder. During the operations disclosed here, any SMS messages received by the service delivery gateway 140 are forwarded through the SMS center 150 and then relayed to the account holder's mobile device 170. Likewise, any SMS messages received by the SMS center 150 are forwarded through the service delivery gateway 140 to other elements of the provider's network. The SMS delivery service 160 may consist of separate devices providing the services of the service delivery gateway 140 and the SMS center 150 or it may be a single device providing both services. Also illustrated in system 100 is the mobile device 170 of the account holder. The mobile device 170 is illustrated as a smart phone but could be any similar device capable of receiving and sending SMS messages. Some examples of other devices include legacy phones, tablets, PDAs, and smart watches.

The authentication portal 120 presents the login interface that is accessed by a user in a web browser. The interface includes elements for logging into the account, resetting the account password, changing the account password, changing the contact information for the account holder, and other functions typical of an authentication web interface. At the authentication portal 120 a request is received from the user via their computer 110 to modify an account of an account holder. The authentication portal 120 will then transmit to the identity provider 130 a request to generate a generated OTP. The request may contain a confirmation flag indicating that confirmation is required by the account holder before generating the OTP. The identity provider 130 will, upon receiving the request to generate the generated OTP, transmit a confirmation request message to an SMS delivery service 160, wherein the confirmation request message notifies the account holder of the request to modify the account and instructs the account holder to reply with a positive confirmation response to approve the account modification. The SMS delivery service 160 then forwards the confirmation request message to the account holder at their mobile device 170. The account holder may reply with a positive confirmation response, such as a YES, a negative confirmation response, such as a NO, or may not reply at all. If the response is a positive confirmation response, it is received at the SMS delivery service 160 and forwarded to the identity provider 130. The identity provider 130 will then generate the generated OTP and forward it through the SMS delivery service 160 to the account holder at their mobile device 170. If it is the account holder requesting the account modification, they will then enter the generated OTP into the interface on the computer 110 provided by the authentication portal 120. In the case of the account holder requesting the account modification, computer 110 and mobile device 170 could actually be the same device. Once the authentication portal 120 receives the received OTP, it is forwarded to the identity provider 130. The identity provider 130 validates that the received OTP matches the generated OTP and sends a notification to the authentication portal 120 that the received OTP has been validated. The authentication portal 120 then proceeds with the account modification as requested by the user. Once the account modification is complete, the authentication portal 120 may trigger an operation completed SMS notification to indicate that the account modification has been completed. The identity provider 130 will then generate the operation complete SMS notification and forward it through the SMS delivery service 160 to the account holder at their mobile device 170.

The account modifications being requested could be any sort of account modifications that require two-factor authentication using an OTP. Examples include resetting a password, changing a password, and changing the contact information for the account holder, including mailing address or email address. The request to generate the OTP may be the “generateTempPin” command and the parameter may be Boolean, containing “True” when confirmation is required and “False” when confirmation is not required, for example. The identity operations may further include transmitting an SMS notification via the SMS delivery service 160 to the account holder indicating that the account modification has been prevented upon receiving a negative confirmation from the account holder. The identity operations may further include transmitting an SMS notification to the account holder via the SMS delivery service 160 indicating that the account modification has been prevented upon the passing of a predetermined timeout period from the notification to the account holder indicating the request to modify the account without receiving the positive confirmation or a negative confirmation. The predetermined timeout period may be set by the provider and could be as low as a few minutes or even up to a full day.

Other network elements may be present in system 100 to facilitate communication but are omitted for clarity, such as access nodes, base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements.

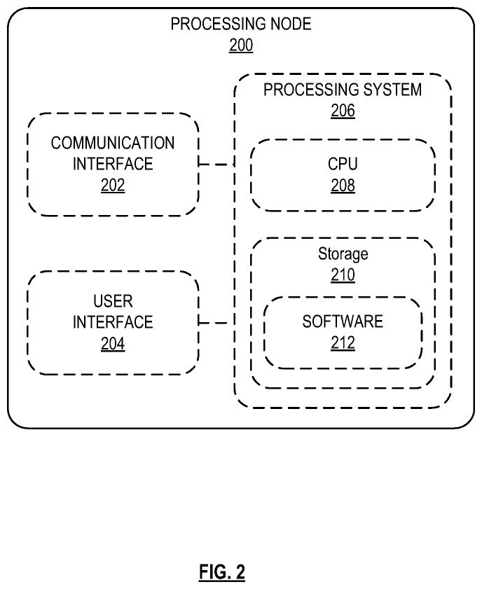

FIG. 2 depicts an exemplary processing node 200 useful for authenticating account changes in a wireless network. The processing node 200 includes a communication interface 202, user interface 204, and processing system 206 in communication with communication interface 202 and user interface 204. Processing system 206 includes a processor 208, storage 210, which can comprise a disk drive, flash drive, memory circuitry, or other memory device including, for example, a buffer. Storage 210 can store software 212 which is used in the operation of the processing node 200. Software 212 may include computer programs, firmware, or some other form of machine-readable instructions, including an operating system, utilities, drivers, network interfaces, applications, or some other type of software. Processing system 206 may include a microprocessor 208 and other circuitry to retrieve and execute software 212 from storage 210. Processing node 200 may further include other components such as a power management unit, a control interface unit, etc., which are omitted for clarity. Communication interface 202 permits processing node 200 to communicate with other network elements. User interface 204 permits the configuration and control of the operation of processing node 200. Processing node 200 may be part of elements shown in FIG. 1, including the authentication portal 120, identity provider 130, service delivery gateway 140, SMS center 150, and SMS delivery service 160.

In an exemplary embodiment, software 212 can include instructions for performing the authentication operations, identity operations, and delivery operations explained above in relation to FIG. 1.

Authentication operations may include receiving a request from a user to modify an account of an account holder. Authentication operations may further include transmitting, to an identity provider, a request to generate a generated OTP, wherein the request to generate the generated OTP includes a confirmation flag indicating that confirmation by the account holder is required before generating the generated OTP. Authentication operations may further include receiving a received OTP from the user and upon receiving the received OTP, transmitting the received OTP to the identity provider. Authentication operations may further include performing the requested account modification once the received ITP is validated.

Identity operations may include upon receiving the request to generate the generated OTP, transmitting a confirmation request message to an SMS delivery service, wherein the confirmation request message notifies the account holder of the request to modify the account and instructs the account holder to reply with a positive confirmation response to approve the requested account modification. The identity operations may further include generating the generated OTP upon receiving the positive confirmation response. The identity operations may further include transmitting the generated OTP to the SMS delivery service. The identity operations may further include receiving the received OTP from the authentication portal and validating that the received OTP matches the generated OTP. The identity operations may include transmitting notification to the authentication portal that the received OTP has been validated.

Delivery operations may include transmitting the confirmation request message to the account holder. Delivery operations may include receiving the positive confirmation response from the account holder and transmitting the positive confirmation response to the identity provider. Delivery operations may include transmitting the generated OTP to the account holder upon receiving the generated OTP from the identity provider.

Identity operations may optionally include upon receiving a negative confirmation response from the account holder, transmitting an SMS notification to the account holder via the SMS delivery service indicating that the requested account modification has been prevented. Identity operations may optionally include upon the passing of a predetermined timeout period from the confirmation request message being transmitted to the account holder without receiving the positive confirmation response or the negative confirmation response, transmitting an SMS notification to the account holder via the SMS delivery service indicating that the requested account modification has been prevented. The predetermined timeout period may be set by the provider and could be as low as a few minutes or even up to a full day.

Authentication operations may optionally include triggering an operation complete SMS notification to the account holder indicating that the requested account modification has been completed. Identity operations may optionally include transmitting the operation complete SMS notification to the SMS delivery service. Delivery operations may optionally include transmitting the operation complete SMS notification to the account holder.

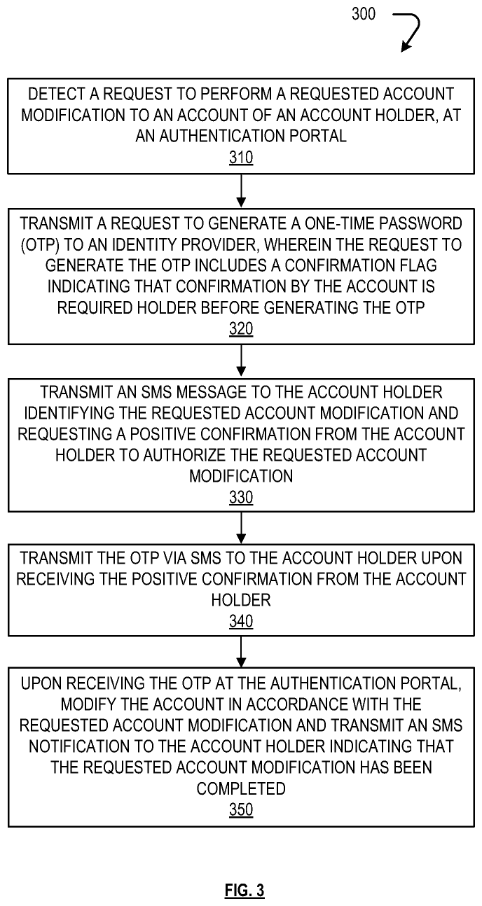

FIG. 3 illustrates an exemplary method 300 for authenticating account changes in a wireless network. Method 300 may be performed by any suitable combination of processors, such as processing node 200. Although FIG. 3 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 300 begins in step 310 where a request to modify an account of an account holder is detected at an authentication portal. Method 300 continues in step 320 where a request to generate an OTP is transmitted to an identity provider. The request includes a confirmation flag indicating that confirmation by the account holder is required before generating the OTP. Method 300 continues in step 330 where an SMS message is transmitted to the account holder. The SMS message identifies the request to modify the account and requests a positive confirmation from the account holder to authorize the account modification. Method 300 continues in step 340 where the OTP is transmitted via SMS to the account holder upon receiving the positive confirmation from the account holder. Method 300 continues in step 350 where, upon receiving the OTP at the authentication portal, the account is modified in accordance with the request to modify the account and an SMS notification indicating that the account modification has been completed is transmitted to the account holder.

Method 300 may include an optional step of transmitting an SMS notification to the account holder indicating that the account modification has been prevented upon receiving a negative confirmation from the account holder. Method 300 may include an optional step of transmitting an SMS notification to the account holder indicating that the account modification has been prevented upon the passing of a predetermined timeout period from the notification to the account holder indicating the request to modify the account without receiving the positive confirmation or a negative confirmation. The predetermined timeout period may be set by the provider and could be as low as a few minutes or even up to a full day. The account modifications being requested could be any sort of account modifications that require two-factor authentication using an OTP. Examples include resetting a password, changing a password, and changing the contact information for the account holder, including mailing address or email address. The request to generate the OTP may be the “generateTempPin” command and the parameter may be Boolean, containing “True” when confirmation is required and “False” when confirmation is not required, for example.

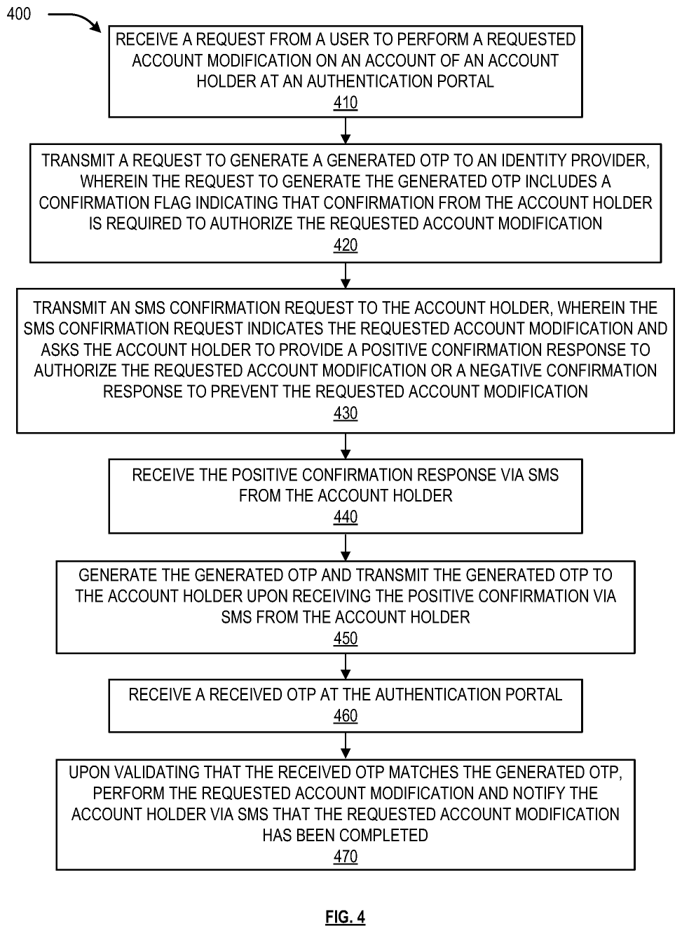

FIG. 4 illustrates an exemplary method 400 for authenticating account changes in a wireless network. Method 400 may be performed by any suitable combination of processors, such as processing node 200. Although FIG. 4 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 400 begins in step 410 where a request from a user to modify the account of an account holder is received at an authentication portal. Method 400 continues in step 420 where a request to generate a generated OTP is transmitted to an identity provider. The request to generate the generated OTP includes a confirmation flag indicating that confirmation from the account holder is required to authorize the account modification. Method 400 continues in step 430 where an SMS confirmation request is transmitted to the account holder. The SMS confirmation request indicates that the account modification has been requested and asks the account holder to provide a positive confirmation response to authorize the account modification or a negative confirmation response to prevent the account modification. Method 400 continues in step 440 where the positive confirmation response is received via SMS from the account holder. Method 400 continues in step 450 where the generated OTP is generated and transmitted to the account holder upon receiving the positive confirmation response. Method 400 continues in step 460 where a received OTP is received at the authentication portal. Method 400 continues in step 470 where, upon validating that the received OTP matches the generated OTP, the requested account modification is performed, and the account holder is notified via SMS that the account modification has been completed.

Method 400 may include an optional step of transmitting an SMS notification to the account holder indicating that the account modification has been prevented upon receiving a negative confirmation response from the account holder. Method 400 may include an optional step of transmitting an SMS notification to the account holder indicating that the account modification has been prevented upon the passing of a predetermined timeout period from the notification to the account holder indicating the request to modify the account without receiving the positive confirmation response or a negative confirmation response. The predetermined timeout period may be set by the provider and could be as low as a few minutes or even up to a full day. The account modifications being requested could be any sort of account modifications that require two-factor authentication using an OTP. Examples include resetting a password, changing a password, and changing the contact information for the account holder, including mailing address or email address. The request to generate the OTP may be the “generateTempPin” command and the parameter may be Boolean, containing “True” when confirmation is required and “False” when confirmation is not required, for example.

In some embodiments, methods 300 and 400 may include additional steps or operations. Furthermore, the methods may include steps shown in each of the other methods. As one of ordinary skill in the art would understand, the methods of 300 and 400 may be integrated in any useful manner and the steps may be performed in any useful sequence.

The exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of authenticating account modifications, the method comprising:
detecting a request to perform a requested account modification to an account of an account holder, at an authentication portal;
transmitting a request to generate a one-time password (OTP) to an identity provider, wherein the request to generate the OTP includes a confirmation flag indicating that confirmation by the account holder is required before generating the OTP;
transmitting an SMS message to the account holder identifying the requested account modification and requesting a positive confirmation from the account holder to authorize the requested account modification;
transmitting the OTP via SMS to the account holder upon receiving the positive confirmation from the account holder; and
upon receiving the OTP at the authentication portal, modifying the account in accordance with the requested account modification, and transmitting an SMS notification to the account holder indicating that the requested account modification has been completed.

2. The method of claim 1, the method further comprising:
upon receiving a negative confirmation from the account holder, transmitting an SMS notification to the account holder indicating that the requested account modification has been prevented.

3. The method of claim 1, the method further comprising:
upon a passing of a predetermined timeout period from the SMS message to the account holder indicating the requested account modification without receiving the positive confirmation or a negative confirmation, transmitting an SMS notification to the account holder indicating that the requested account modification has been prevented.

4. The method of claim 1, wherein the requested account modification is a reset password operation.

5. The method of claim 1, wherein the requested account modification is a change password operation.

6. The method of claim 1, wherein the requested account modification is an operation to change contact information of the account holder.

7. The method of claim 1, wherein the confirmation flag is a Boolean parameter for a generateTempPin operation.

8. A system, the system comprising:
an authentication portal including at least one electronic processor configured to perform authentication operations, the authentication operations comprising:
receiving a request from a user to perform a requested account modification of an account of an account holder;
transmitting, to an identity provider, a request to generate a generated one-time password (OTP) containing a confirmation flag indicating that confirmation by the account holder is required before generating the generated OTP;
receiving a received OTP from the user and upon receiving the received OTP, transmitting the received OTP to the identity provider; and
performing the requested account modification once the received OTP is validated;
the identity provider including at least one electronic processor configured to perform identity operations, the identity operations comprising:
upon receiving the request to generate the generated OTP, transmitting a confirmation request message to an SMS delivery service, wherein the confirmation request message notifies the account holder of the requested account modification and instructs the account holder to reply with a positive confirmation response to approve the requested account modification;
generating the generated OTP upon receiving the positive confirmation response;
transmitting the generated OTP to the SMS delivery service;
receiving the received OTP from the authentication portal;
validating that the received OTP is matches the generated OTP; and
transmitting notification to the authentication portal that the received OTP has been validated;
the SMS delivery service including at least one electronic processor configured to perform delivery operations, the delivery operations comprising:
transmitting the confirmation request message to the account holder;
receiving the positive confirmation response from the account holder;
transmitting the positive confirmation response to the identity provider; and
upon receiving the generated OTP from the identity provider, transmitting the generated OTP to the account holder.

9. The system of claim 8, wherein the identity operations further comprise:
upon receiving a negative confirmation response from the account holder, transmitting an SMS notification to the account holder via the SMS delivery service indicating that the requested account modification has been prevented.

10. The system of claim 8, wherein the identity operations further comprise:
upon a passing of a predetermined timeout period from the confirmation request message being transmitted to the account holder without receiving the positive confirmation response or a negative confirmation response, transmitting an SMS notification to the account holder via the SMS delivery service indicating that the requested account modification has been prevented.

11. The system of claim 8, wherein the authentication operations further comprise triggering an operation complete SMS notification to the account holder indicating that the requested account modification has been completed;
wherein the identity operations further comprise transmitting the operation complete SMS notification to the SMS delivery service; and
wherein the delivery operations further comprise transmitting the operation complete SMS notification to the account holder.

12. The system of claim 8, wherein the requested account modification is a reset password operation.

13. The system of claim 8, wherein the requested account modification is a change password operation.

14. The system of claim 8, wherein the confirmation flag is a Boolean parameter for a generateTempPin operation.

15. A method of authenticating account modifications, the method comprising:
receiving a request from a user to perform a requested account modification on an account of an account holder at an authentication portal;
transmitting a request to generate a generated OTP to an identity provider, wherein the request to generate the generated OTP includes a confirmation flag indicating that confirmation from the account holder is required to authorize the requested account modification;
transmitting an SMS confirmation request to the account holder, wherein the SMS confirmation request indicates the requested account modification and asks the account holder to provide a positive confirmation response to authorize the requested account modification or a negative confirmation response to prevent the requested account modification;
receiving the positive confirmation response via SMS from the account holder;
upon receiving the positive confirmation response, generating the generated OTP and transmitting the generated OTP to the account holder;
receiving a received OTP at the authentication portal; and
upon validating that the received OTP matches the generated OTP, performing the requested account modification and notifying the account holder via SMS that the requested account modification has been completed.

16. The method of claim 15, the method further comprising:
upon receiving the negative confirmation response from the account holder, transmitting an SMS notification to the account holder indicating that the requested account modification has been prevented.

17. The method of claim 15, the method further comprising:
upon a passing of a predetermined timeout period from the transmitting the SMS confirmation request to the account holder without receiving the positive confirmation response or the negative confirmation response, transmitting an SMS notification to the account holder indicating that the requested account modification has been prevented.

18. The method of claim 15, wherein the requested account modification is a reset password operation.

19. The method of claim 15, wherein the requested account modification is a change password operation.

20. The method of claim 15, wherein the confirmation flag is a Boolean parameter for a generateTempPin operation.
